(19) United States
(12) Patent Application Publication
(10) Pub. No.: US 2012/0313457 A1
(43) Pub. Date: Dec. 13, 2012

(54) GRAVITY-ASSISTED GEOMAGNETIC GENERATOR

(76) Inventor: Puthalath Koroth Raghuprasad, Odessa, TX (US)

(21) Appl. No.: 13/569,440

(22) Filed: Aug. 8, 2012

Related U.S. Application Data
(63) Continuation of application No. 12/910,912, filed on Oct. 25, 2010.

(51) Int. Cl. H02K 41/06; H02K 53/00

(52) U.S. Cl. 310/12.12; 74/DIG. 9

(57) ABSTRACT

A geomagnetic power generating apparatus has a guide means, one or more moving permanent magnets, a plurality of coils and a battery or series of batteries. The movement of the one or more permanent magnets generates an electric current in the coils to charge the battery. The moving magnets generate electric currents within the coils causing a major propulsive magnetic field to act on the magnet augmenting its momentum along the guide path.

### RELATED APPLICATIONS

The present invention is a continuation of U.S. application Ser. No. 12/910,912 filed on Oct. 25, 2010 entitled “Gravity Assisted Geomagnetic Generator”.

### TECHNICAL FIELD

The present invention relates to an apparatus that generates electric currents through a plurality of coils to power or charge a battery using one or more moving permanent magnets passing through coils. This power generation is sustained by the persistence of magnetism in the permanent magnets for long periods, perhaps indefinitely. This, we contend is because the magnets are constantly being re-magnetized by proximity to the magnetic field of the earth (geomagnetism). The movement of the magnet(s) is maintained by strategic design and deployment of the coils which themselves act as “air coils” and thus drive the magnets by repulsion of like magnetic poles. In this, momentum imparted by gravity and mass in conjunction with velocity, function in a complimentary fashion. It will be clear to everyone that electric power is generated simply by converting magnetic fluxes through known principles, but with special design features that help and augment the process; this generator apparatus does not violate the first law of thermodynamics.

### BACKGROUND OF THE INVENTION

The ability to generate an electric current by passing a magnet through a coil of electrically conductive wires is well known, and commonly referred to as the Michael Faraday effect.

The use of wires wound around a rotating bank of magnets is a common practice in the manufacture of electric motors and electric power generators.

It has long been a common practice to use naturally occurring mechanical power to generate electricity. Hydraulic generation of power uses water flows to turn turbines; wave's motion has been proposed to generate electricity; new wind-driven propellers are now making electricity and solar energy can be captured and converted to electric energy by using solar panels.

All of these devices convert an external physical force or energy into electricity. The biggest problem with such devices is that the source of energy is not always constant. Water flows, wind and solar energy often-times are not predictable and, in the case of solar power, it is not available during the night.

It is, therefore, an objective to develop electricity from a source that is relatively constant and predictable. The earth's core has a large molten mass of iron. The motion of solid earth's crust around the molten iron core by earth's axial rotation is believed to create geomagnetism. The energy created by this magnetic field is often visible in the northern sky, called the northern lights or Aurora Borealis. Permanent magnets likely draw on the earth's magnetic core to sustain their magnetism. Unlike solar power, which needs sunlight to generate power, and therefore is limited to daylight hours for power generation, geomagnetic fields are a substantially constant source of continuous power available as long as the earth's core remains molten. Permanent magnets, over a very long time, will lose some of their power in terms of their magnetic field strength, however, even this can be recharged by exposure to high intensity magnetism. Accordingly, the earth's lower field energy provides a constant equivalent of a trickle charge to maintain the permanent magnets field energy over long periods of time, hence the name permanent has been applied to these magnets.

The present invention as described below, rather than creating free energy, actually taps into the enormous hidden potential of energy from mother earth. First, the magnet is used to convert magnetism to electricity and, the magnet itself is deriving its power from earth's magnetism (Geomagnetism). Next, by using the earth's gravity in conjunction with “air coils” to provide momentum, momentum being a product of weight (mass×gravity) and velocity, means that by moving permanent magnets into coils provides a source of electricity, which by the use of gravity and the polarity of magnetic fields, can produce a propulsion of moving magnets in coils to produce electricity in the device of the present invention. The above motion (that of adding gravity into the mix) is a novel assumption by the present invention.

The current scientific principles describe momentum as the product of mass times velocity. Our contention is gravity augments the momentum as described below. If one undertakes a thought experiment in which the experimenter travels the same velocity as on the surface of the earth, but in a spaceship far away from the influence of any celestial body (i.e. new zero gravity in the vacuum of space) an abrupt braking will not result in any momentum.

It is a further object to create a device that can generate electricity with very few losses in efficiency while having no adverse effects on the surrounding environment.

The following described preferred invention uses a magnetic repulsive force generated when two like poles are in close proximity to maintain motion while converting the moving magnetic force fields into electricity to generate a power supply. The provision of a larger number of windings on one end of the coil is designed to boost this repulsive force to advantage, while reducing any drag on the system by any opposing attractive force.

### SUMMARY OF THE INVENTION

A geomagnetic power generating apparatus has a guide means, one or more moving permanent magnets, a plurality of coils and a battery or series of batteries. In the one or more moving permanent magnets, each permanent magnet has a north polarity at a first end and a south polarity at the opposite second end. The one or more magnets are located and guided along a guide path by the guide means. The plurality of coils has each coil positioned around the guide means, encircling both the guide means and the guide path along which one or more permanent magnets move. Each coil has a cross section having an increasing number of windings extending from a minimal winding at first end to a maximum winding at second end. The battery or a series of batteries is connected to the plurality of coils. When the one or more permanent magnets are moved, with one magnet approaching toward each coil and as the N or S end of the magnet approaches inside the coil an electric current is created along with a magnetic field having an opposite polarity at the narrow end of the coil relative to the entering end of the magnet. The movement of the one or more permanent magnets inside the coil generates an electric current in the coils to charge the battery. When the magnet is leaving the maximum-winding second end of the coil, a similar or like pole S to S or N to N polarity exists, causing the magnetic field of each of the coils to push the similar polarity second end of the magnet out of the coil, propelling the magnet to the next coil. The moving magnets generate electric currents within the coils causing a major propulsive magnetic field to act on the magnet, thus augmenting its momentum along the guide path.

The guide means forms a circular guide path. The one or more permanent magnets preferably are a plurality of permanent magnets fixed equidistantly from each adjacent magnet. The plurality of coils is equidistantly spaced relative to an adjacent coil around the guide means at a distance equal to the fixed distance of the adjacent magnets. Each permanent magnet is fixed relative to other permanent magnets by a connecting structure and each permanent magnet is spaced equidistantly on the connecting structure. In the preferred embodiment of the invention, the number of permanent magnets is equal to the number of coils. The movement of the magnets is substantially aided by the provision of ball bearings on the floor of the guide path, designed to reduce the losses due to inertia.

### BRIEF DESCRIPTION OF THE DRAWINGS

FIG. 1 is a perspective view showing an exemplary apparatus made according to the present invention.

FIG. 2 is a perspective exploded view of the exemplary apparatus of FIG. 1 with the top cover removed to show inside the lower housing of the apparatus.

FIG. 3 is a perspective view of the internally stored power generating apparatus with the central battery and circuitry removed along with the outer housing portions removed taken from FIG. 1.

FIG. 4 is a perspective view of the apparatus showing the guide means assembly of FIG. 3 with the magnets and coils removed showing the ends prior to being fastened.

FIG. 5 is an enlarged view of the ends of the guide means assembly showing the bearings in the groove or guide path of the guide means.

FIG. 6 is a partial top view of a guide means according to the present invention.

FIG. 7 is a perspective view of a magnet with a pair of wire structures inserted with holding fasteners not secured.

FIG. 8 is a cross sectional view of a magnet having the wire structures secured by the fasteners.

FIG. 9 is a perspective view of the magnets connected to wire structures with one magnet not attached leaving an opening in the circular structure of magnet shown depicting the remaining magnets being attached to form the loop or circle of equidistant magnets above the guide means. Also shown is the completed guide path with the railings and ball bearings on the floor.

FIG. 9A is an enlarged view of the guide structure ends taken from FIG. 9.

FIG. 9B is a perspective view of the ring of magnets positioned in the guide means with the openings of the ends of both the ring and guide means shown prior to installation of the coils.

FIG. 10 is a perspective view of the coils being slipped over ends of the guide means encircling the guide means and plurality of magnets.

FIG. 10A is a perspective view of the guide means with magnets installed in the guide path GP, but prior to affixing the ends of the ring and the guide means.

FIG. 11 is a cross sectional view of the apparatus according to the invention taken from FIG. 1.

FIG. 12 is an end view of the coil, guide means with a magnet inside the coil taken from FIG. 11.

FIGS. 13A and 13B: 13A shows the magnet prior to entering the coil while 13B depicts the lack of a field in the coil, but shows the magnetic field and polarity of the magnet.

FIGS. 14A and 14B: 14A shows the magnet after entering into the coil, creating a current and a polarity in the coil. FIG. 14B shows the magnetic field intensity and polarity of the magnet and the coil in this entering position.

FIGS. 15A and 15B: 15A shows the magnet leaving the coil. FIG. 15B shows the polarity and magnetic field intensity as the magnet leaves the coil, the like south poles generating a repulsive force pushing the magnet out and toward the next coil.

### DETAILED DESCRIPTION OF THE INVENTION

The following language describes the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification. For purposes of this application, the various embodiments illustrated in the figures each use the same reference numeral for similar components. The structures employ basically the same components with variations in location or quantity thereby giving rise to the alternative constructions in which the inventive concept can be practiced.

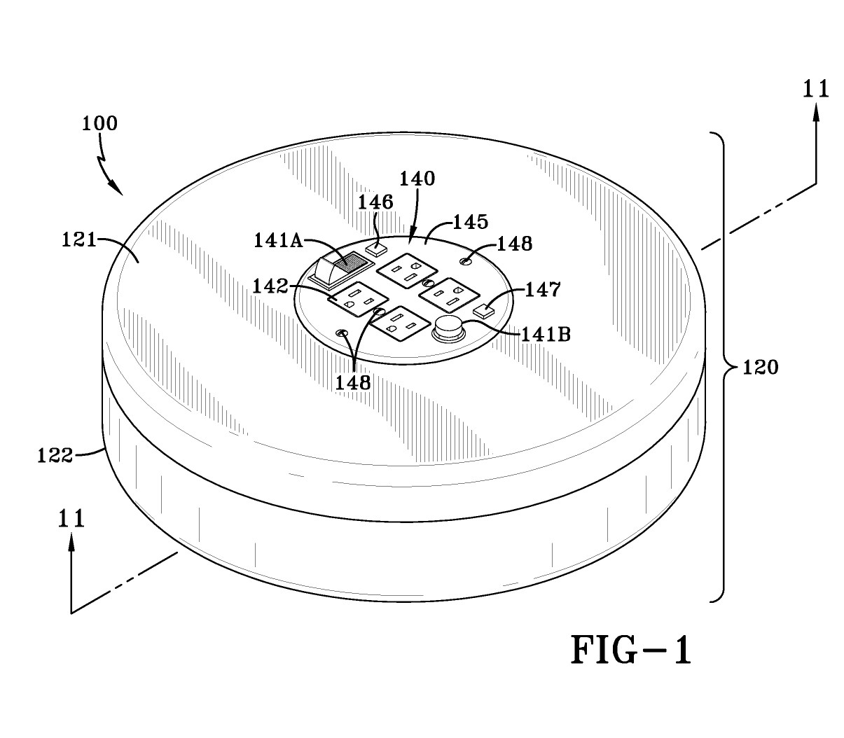

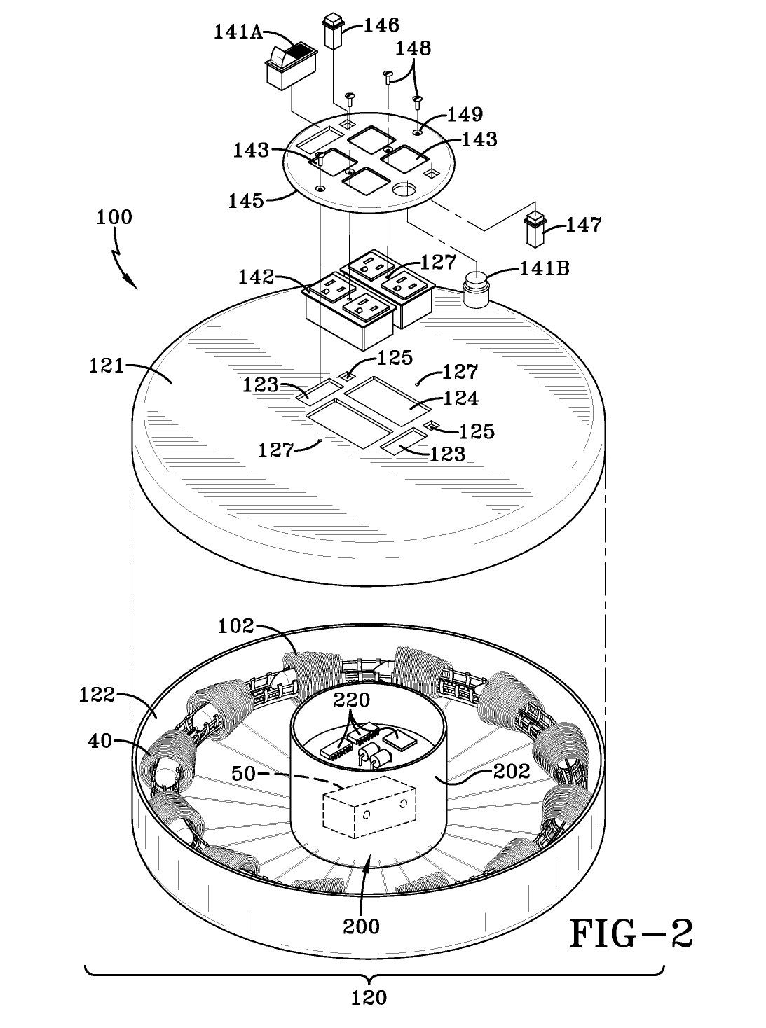

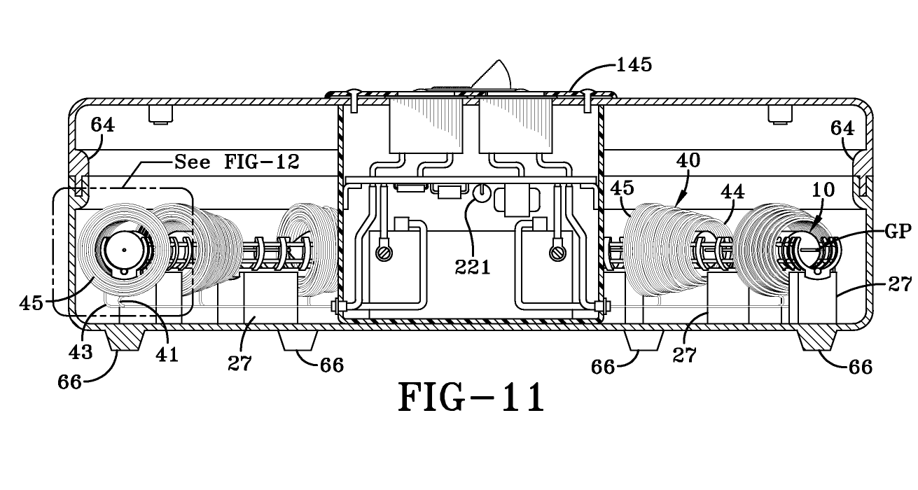

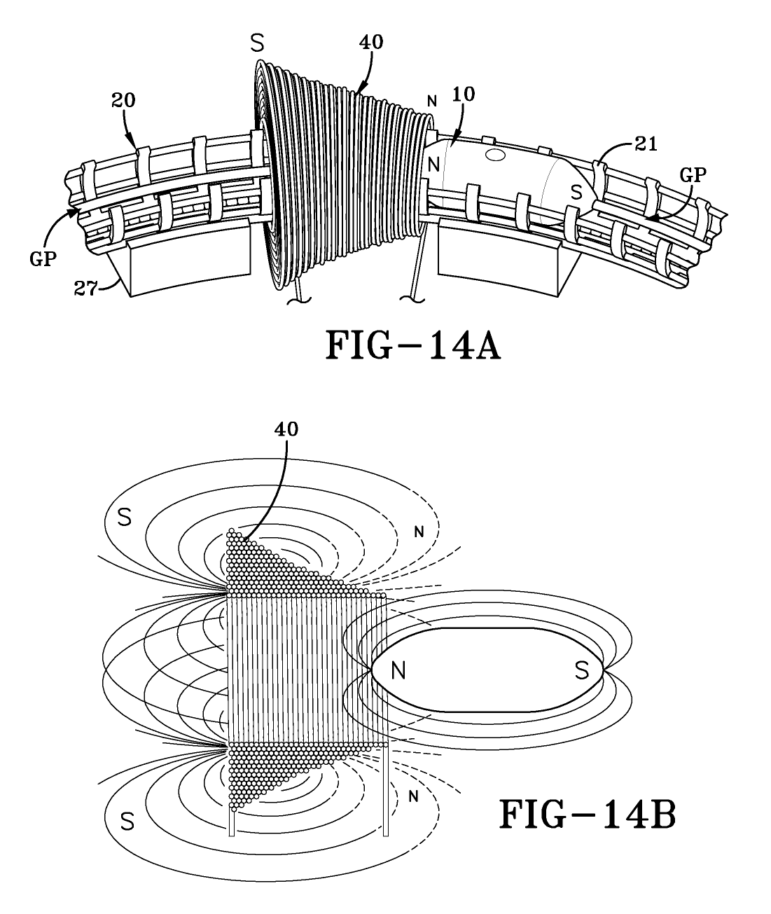

A geomagnetic power generator apparatus 100 of an exemplary first embodiment of the invention is illustrated in FIGS. 1-15B. As shown in FIG. 1, the generator apparatus 100 has an external housing 120 made of two pieces, an upper housing 121 and a lower housing 122. In the center of the upper housing 121 is a central control assembly 140. This assembly 140 shows a start switch 141A and an on/off switch 141B, four plug outlets 142 and a pair of power indicator status lights 146, 147 which are covered by a circular cover plate 145 with fastener openings 149 as shown in FIG. 2. The cover plate 145 is held in place by a plurality of screws 148. The plate 145 has several openings 143 for the various components to pass through upon assembly. The entire apparatus 100 rests on a plurality of feet 66, the feet 66 preferably being made of an elastomer to dampen any vibrations as shown in FIG. 11, but hidden from view in FIG. 1.

As shown in FIG. 2, the generator apparatus 100 has the upper housing 121 removed from the lower housing 122 exposing the internally stored components.

The upper housing 121 has openings 123, 124 and 125 to allow the switches 141A and 141B, the plug outlets 142 and the indicator lights 146, 147 to pass. The plug outlets 142 are attached to the plate 145 by fasteners 148 and the plate 145 is similarly attached to the upper housing 121 at threaded holes 127 by the fasteners 148. The wires connecting the outlet plugs 142 are illustrated or shown attached to a power source in FIG. 11. The upper housing 121 and lower housing 122 have complimentary interlocking portions 64 that can be snapped together to complete the housing assembly 120 as shown in FIG. 11. These portions 64 allow easy access to the internal components of the apparatus 100 as shown in FIGS. 2 and 11.

When the power generator 100 is switched to start using the start switch 141A, the apparatus 100 will start pulsing power which will be drawn from one or more batteries 50 causing the permanent magnets 10 to be moved to a position to start to activate the coils 40, which can alternatively be accomplished manually by tilting the assembly or preferably by using an external magnet and the on/off switch 141B can be turned to on. Once the magnets 10 are set in motion, the indicator light 146 will stop pulsing; the batteries 50 will be charged electrically and once charging occurs, it can be used to power electric appliances attached to the apparatus through the outlet plugs 142. The generator 100 will indicate a standby condition showing a red pulsing light indicator 146 when initially lit and switches to a solid light to show a charging condition when a light 147 is lit showing the green lights when the apparatus 100 is ready for use, the indicator lights 146, 147 being red or green respectively to reflect a status. Once the status level reached a charged state a green light shows a sufficient amount of power is being created to operate externally attached appliances or equipment.

The above description is simply one of several examples of the uses for the apparatus 100 of the present invention.

As further shown in FIG. 2, the power generation is all created in the assembly of components stored in the lower housing 122. In the center of the device is shown a power supply assembly 200 including one or more batteries 50 (shown in dashed lines) stored in the cylindrical housing 202 and an electronic power conversion assembly 220 for converting direct current generated by the apparatus 100 to an alternating current (if desired). The power conversion assembly 220 includes a circuit board, rectifiers and other electronic components to achieve the desired power conversion as is well understood in the art. The power conversion assembly further includes a one-way current flow diode 221 or equivalent device, as shown in FIG. 11, which only allows the coils 40 to pass current into the power conversion assembly 220 and prevents current from the battery to back flow a current into the coils. In this way the coils only have a current generated as a magnet passes through the coil.

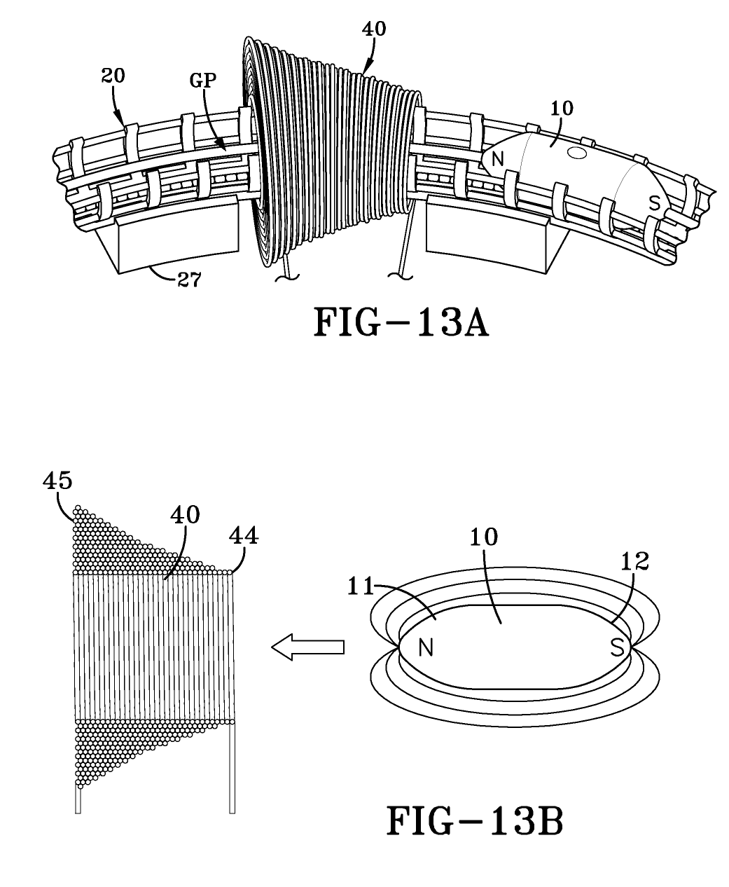

The power generation assembly 102 is used to create the power to charge the batteries 50 shown in dashed or phantom lines. The annular power generation assembly 102 has a plurality of central coils 40 which capture moving magnetic fields as shown in FIGS. 13A-15B, and convert this power into an electric current which is fed back to the batteries 50 to charge them, as is discussed in greater detail as follows.

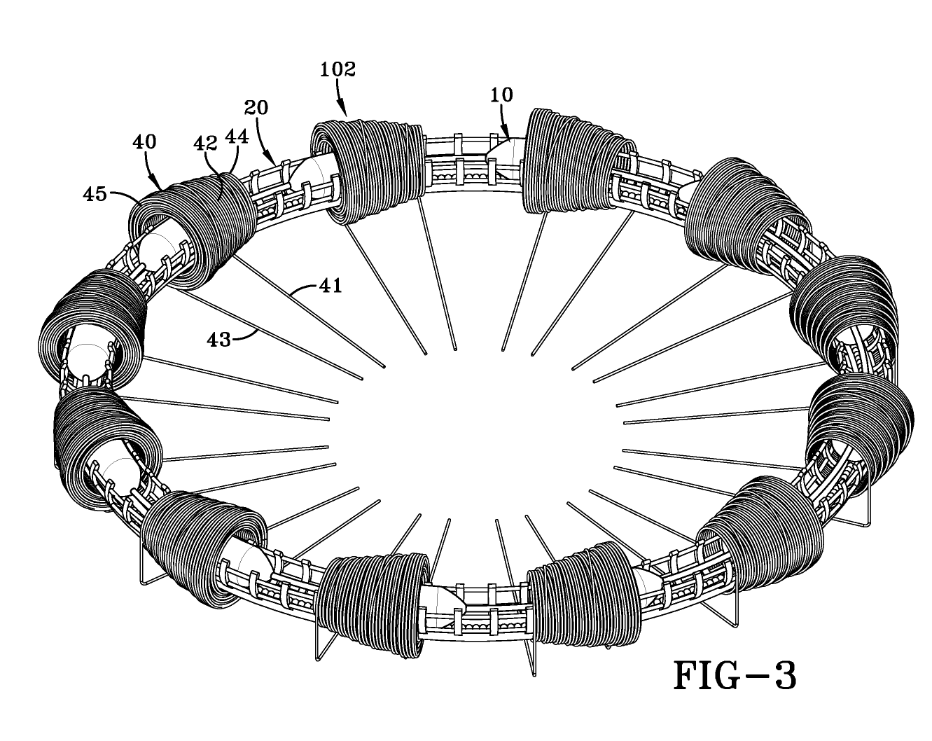

With reference to FIGS. 3, 4, 5, 6, 8, 9 and 10 the exemplary power generating assembly 102 for the apparatus 100 is shown.

As shown in FIG. 3, the power generating assembly 102 is shown as a circular ring having a plurality of coils encircling a skeletal guide means 20 into which a plurality of permanent magnets 10 are positioned equidistantly. As shown, the circular unit has the coil wires 42 extending from a narrow end 44 with a wire 41 projecting radially to the center. As the coil 40 is wound from the narrow end 44, it increases substantially in the number of windings toward the second end 45 wherein a wire 43 extends radially towards the center. These wires 41 and 43 are ultimately connected electrically to the power supply assembly 200. The power supply assembly 200 is not illustrated for purposes of clarity so one can appreciate the overall structure of the power generating assembly 102. The narrow first end of the coil 44 and its opposite thick second end 45 are wound in such a fashion that as a magnet 10 passes in a coil, the coil generates its own magnetic field. What is unique about this assembly 102 is that there are no switches or any other power-consuming devices required for actuation of the coils 40 and as will be discussed later in this detailed description, the movement of the magnets 10 entering the coils 40 creates an electric current within each coil 40 wherein that current produces a magnetic field of a particular polarity N or S and as the magnet 10 leaves the coil 40, a like polarity S to S or N to N created in the coil 40 will push the magnet 10 in a forward direction towards the next adjacent coil 40.

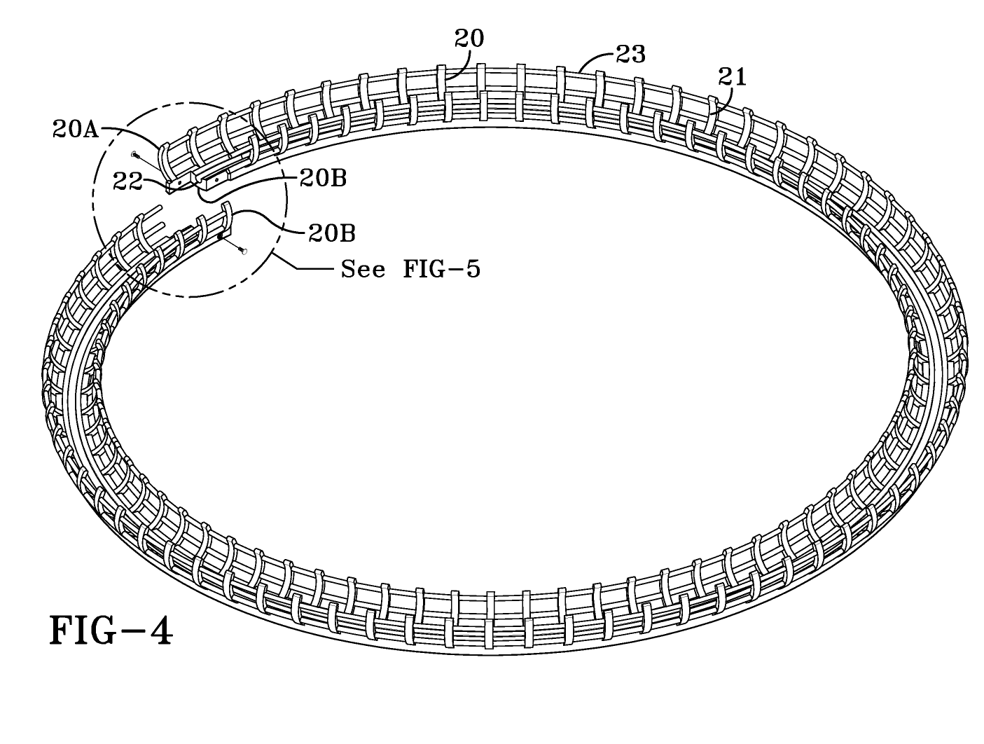

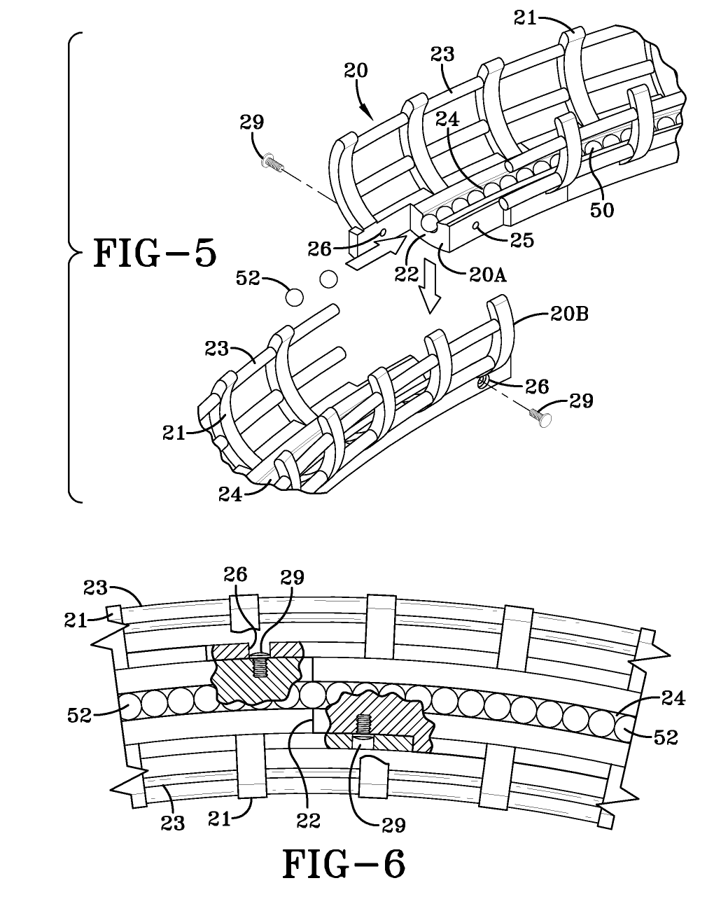

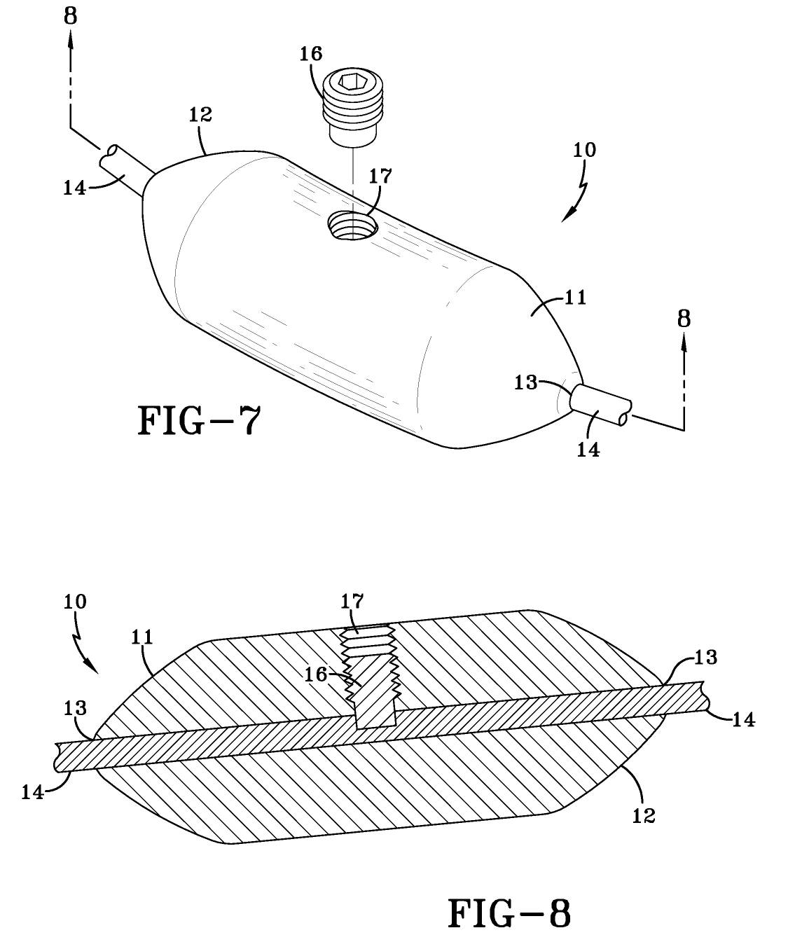

To better understand the entire assembly of the components of the power generating apparatus 102, attention is called to FIG. 4 wherein the guide means 20 is illustrated having an opening or pair of ends 20A and 20B designed to be fastened together to form a circular ring. The guide means 20 as shown is a skeletal structure having a base 22 with an internal groove 24 extending annularly around the entire guide means 20. Projecting outwardly from the base 22 are a plurality of ribs 21 that extend outwardly on each side of the base 22 forming an arcuate or curved structure interconnected by circumferential connecting rails 23. With reference to FIG. 5, the ends 20A and 20B of the guide means 20 are illustrated, each end 20A and 20B has an opening or hole 26 through which a threaded fastener 29 is extended that connects and screws into a threaded hole 25 the opposite end into the base 22 at the threaded opening 26. As further illustrated, a plurality of non-magnetic, preferably stainless steel, aluminum, ceramic, crystal dust or other synthetic ball bearings 52 are illustrated that fit into the groove 24. These grooves 24 are designed to capture the ball bearings 52 allowing an external surface to project outwardly above the groove 24 in order to support in a low contact, low friction way the magnets 10 that will be passing through the guide means 20. The guide means 20 open above the bearings 52 and between the opposing ribs 21 forms the guide path GP through which the magnets 10 will pass. As shown in FIG. 6, the threaded fasteners 29 when bolted together complete the circular guide means 20.

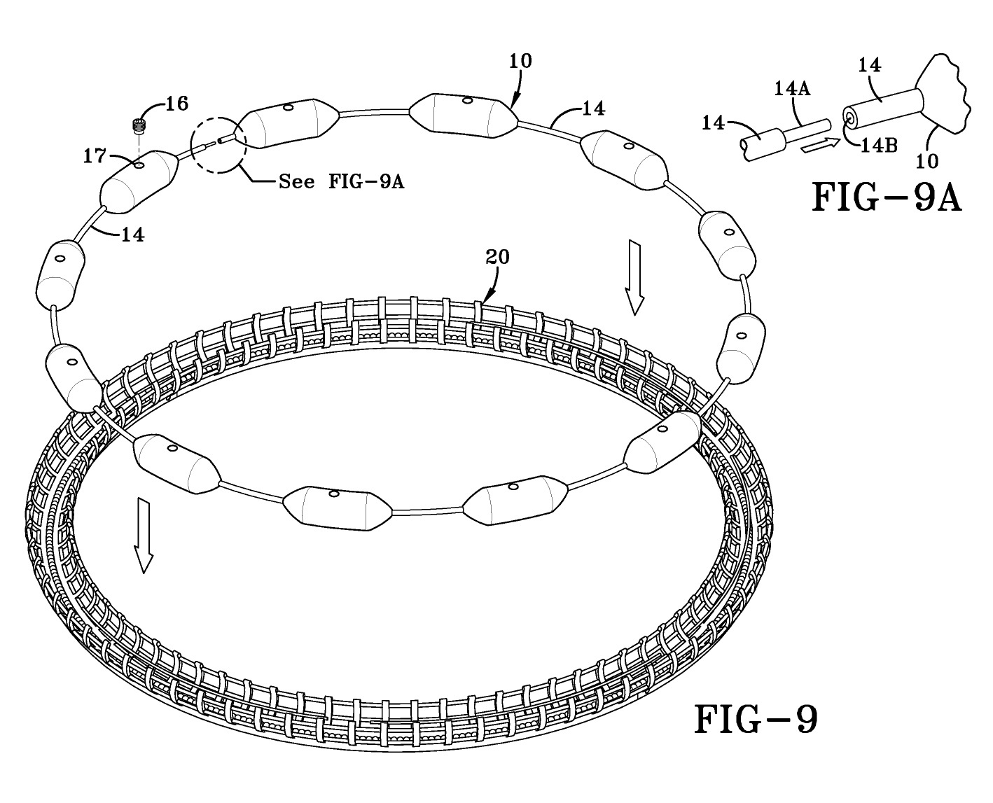

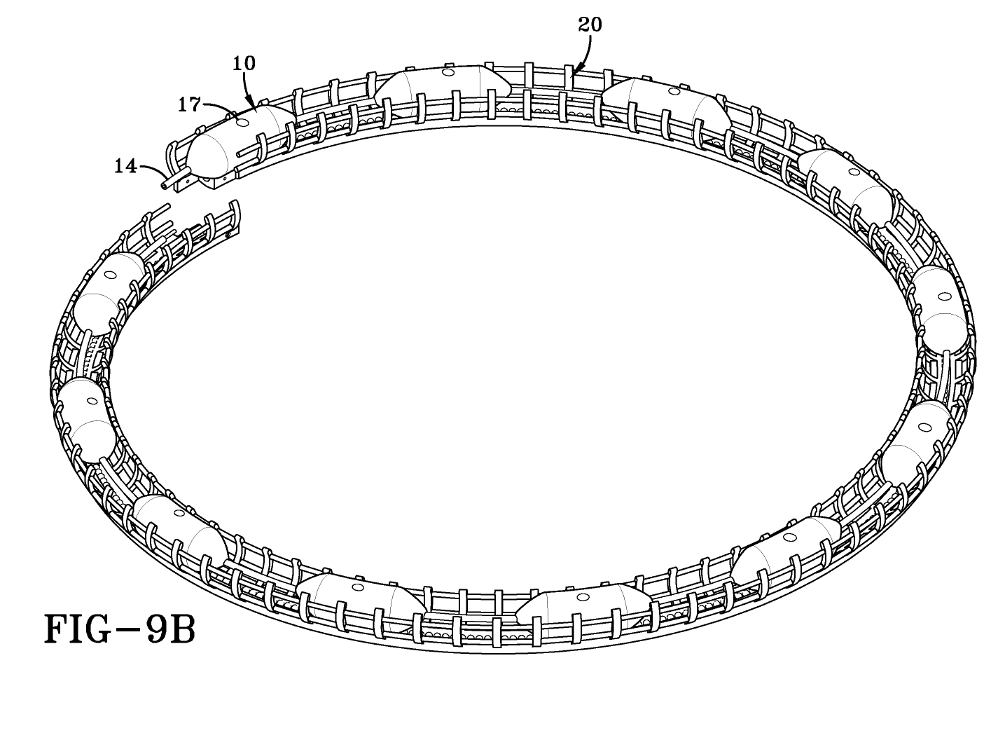

With reference to FIG. 7, a magnet 10 is shown having an aerodynamic first end 11 and a similarly aerodynamic second end 12; at each end 11 and 12 there is a hole 13 into which a support structure is inserted. As shown in FIG. 8, the wire 14 is inserted through the magnets to predetermined locations wherein a threaded fastener 16 is screwed into the threaded holes 17 in the magnet 10 securing the support wire 14. Alternatively, the wire 14 can be press fitted or adhesively attached to the magnets.

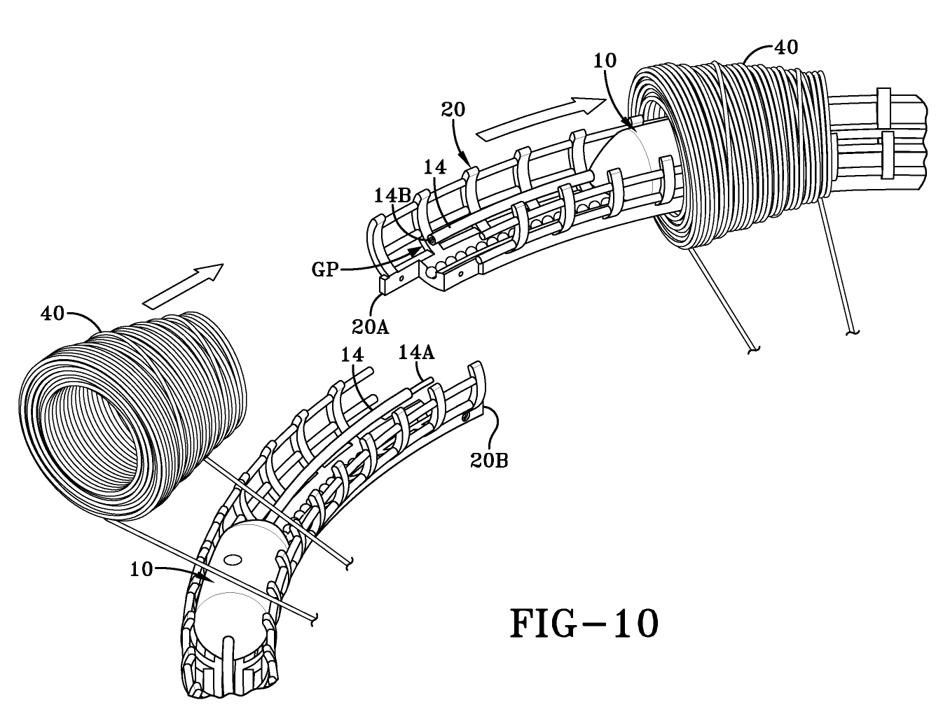

With reference to FIG. 9, a plurality of these magnets can be assembled forming an annular ring. As illustrated in FIG. 9, above the guide means 20 is illustrated a plurality of these magnets 10 wherein the ring supporting the magnets 10 has an opening or split wherein one male end 14A of the ring 14 and one female end 14B are not connected. By leaving one magnet unattached, it is possible to either thread or pass the magnets 10 through the end 20A or 20B of the guide means 20 as shown in FIGS. 4 and 5, or preferably to snap down the connected magnets 10 as an assembly into the guide means forcing them through the opposing ribs 21 which can flex open to receive the magnets on assembly, as assembled shown in FIG. 9B.

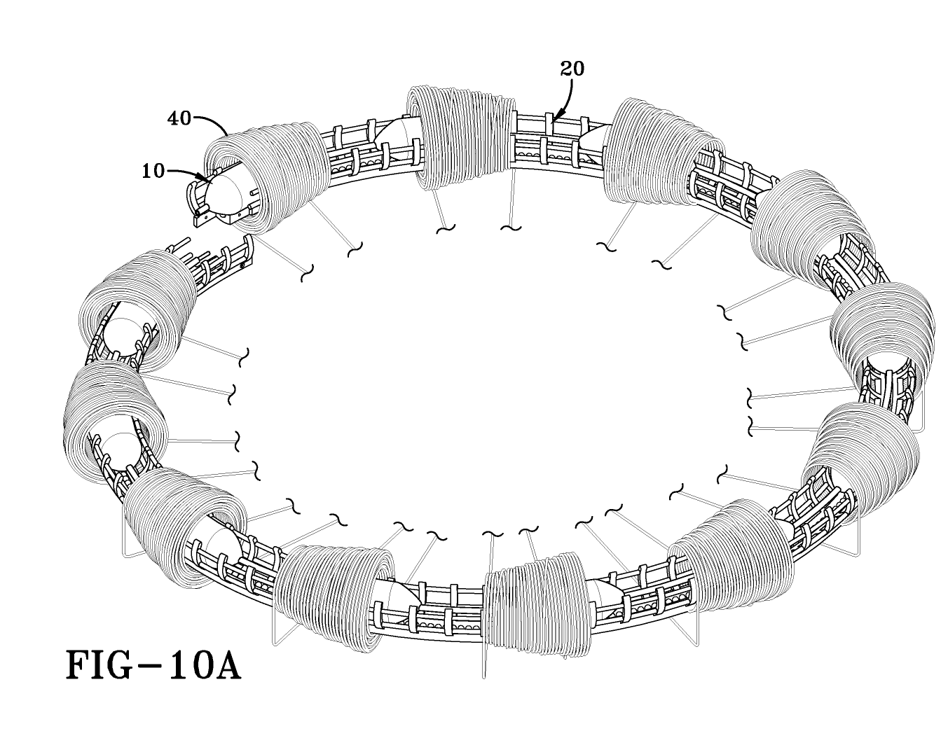

With reference to FIG. 10, once the magnets 10 are in position, the opened end 20A of the guide means 20 can be extended upwardly in such a fashion that the coils 40 can be slipped over the guide means 20 and the magnets 10 as illustrated. Once all the coils 40 have been installed encircling the guide means 20, as shown in FIG. 10A, the ends 14A and 14B of the ring 14, shown in FIG. 9A, can be positioned to be pressed together completing the circular ring of the support structure wire 14. This forms a complete ring of the magnets 10 and then the guide means 20 itself can be secured at the ends 20A and 20B as previously discussed in FIG. 6. Once these assemblies are completed, the power generating assembly 102 is complete.

As shown in FIG. 11, the cross sectional view of the apparatus 100 illustrates that the guide means 20 with all the coils 40 in position can be snapped onto feet or legs 27 to secure the assembly to a bottom portion of the housing 122. Once the coils 40 have been positioned around the apparatus 100, they can be connected to the battery 50 or power supply assembly 200 as further shown in FIG. 11. Once all the coils 40 are connected, the device is fundamentally ready for use. Preferably the legs 27 are sized to help insure the coil 40 spacing is fixed around the guide means 20.

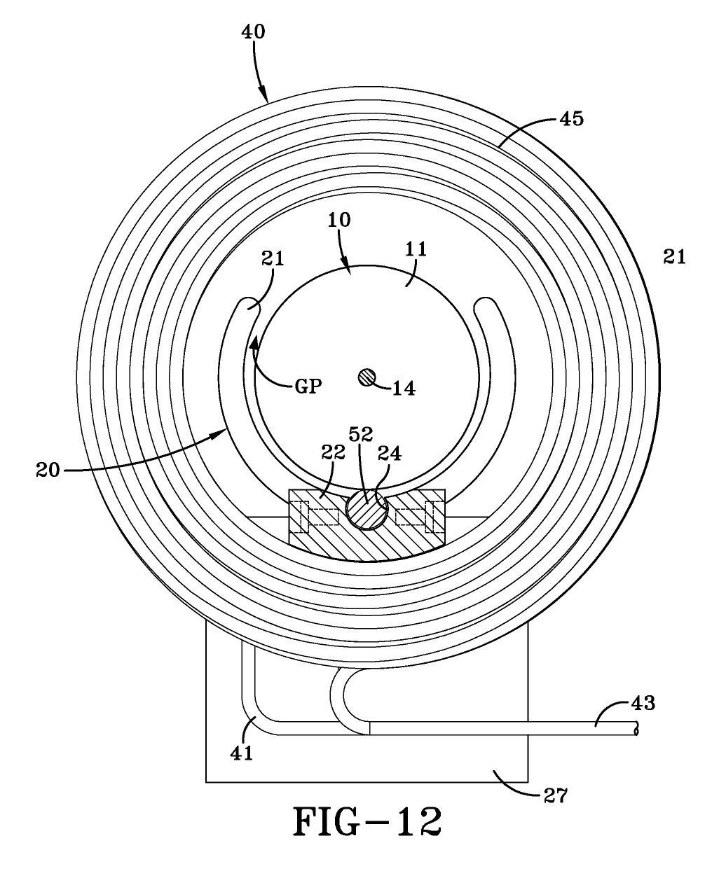

With reference to FIG. 12, it is possible to see the thick second end 45 of the coil 40, inside of which is the guide means 20 with the ribs 21 extending upwardly from the base 22 and the ball bearings 52 nested in the groove 24 with the permanent magnets rested on the top of the bearings 52.

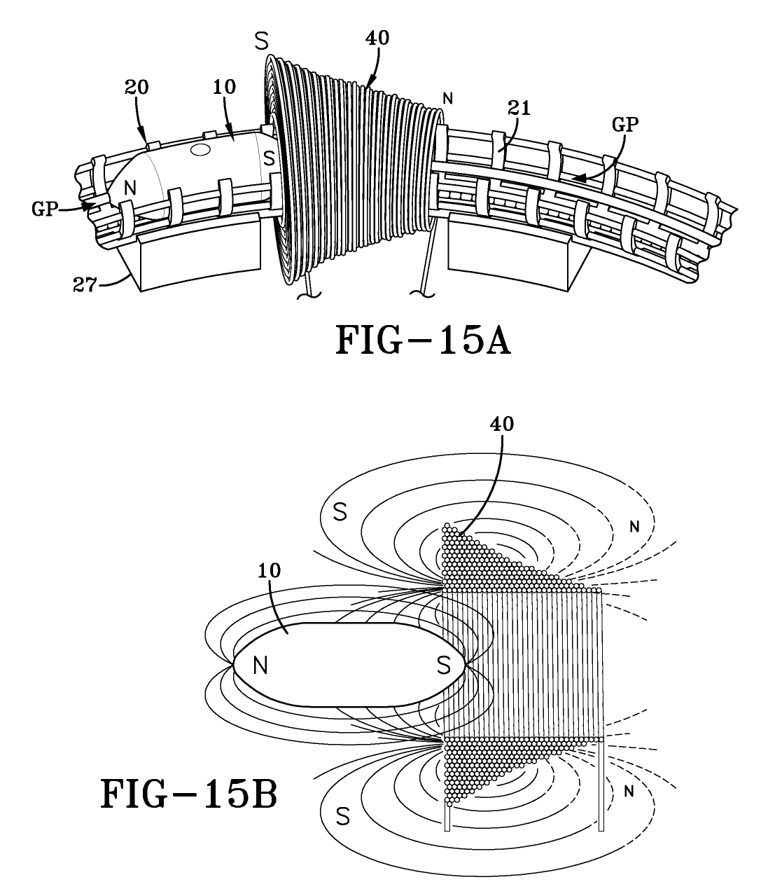

With reference to FIGS. 13A-15B, the creation of the magnetic fields can be most easily appreciated by looking at the sequence of operation as one of the magnets 10 moves into a coil 40. The magnet 10 has a north pole N as illustrated in the example provided. The magnet has the north pole N or polarity N at an end 11 and the end 12 having a south pole S or polarity S. As the magnet 10 approaches the coil 40, there is no magnetic field or current in the coil 40, shown in 13A and 13B; as such the magnet 10 enters freely. As soon as the magnet 10 enters the coil 40, the magnetic field N of the magnet 10 produces an electric current inside the coil 40. This electric current generates its own magnetic field N. The coil 40 is wound in such a way that the narrow end 44 has a north polarity N and the thicker second end 45 has a south polarity S, as illustrated in 14A and 14B. As the magnet 10 proceeds through the coil 40, a current is produced that can charge the battery 50 and as the magnet 10 leaves the coil 40 a south polarity S at the thick second end 45 on the coil 40 is opposed to the south polarity S of a magnet 10, as shown in FIGS. 15A and 15B. When this occurs a repulsive force is created which pushes the magnet 10 forward out of the coil 40 towards the next adjacent coil 40 (to the left in FIG. 15A). It can be appreciated since all the coils 40 and magnets 10 are equidistant, this action is occurring at each location where there is a coil 40 and a magnet 10 passing, as such the additive effect of the repulsive force increases and sustains the momentum of the moving magnets 10 as they traverse around the guide path GP. As illustrated, the coils 40, by having fewer windings at the first end 44 exhibit a rather weak magnetic field N. At the opposite thick second end 45 the south polarity field S having the current passing through more windings exhibits a much stronger repulsive magnetic field shown by the larger number of field lines in FIG. 15B. This asymmetric field pattern maximizes the force used to sustain momentum of the passing magnets 10. The example as shown has the polarity structured such that the thick end is S on the coil, however, both the coil 40 and magnets 10 could have reversed polarities as long as the like-poles are at the thick second end 45 of the coil 40 and rear end of the moving magnets 10.

The best characteristic of this apparatus 100 is that there are no switches required to activate the coils 40, but the magnets 10 generate a field generation by creating the current in the coil 40 as they pass, as such the coils 40 themselves are switched from no field to a field having a polarity north at one end 44 and south at the other end 45. This feature is used to not only propel the magnet 10 forward within the guide means 20 when the apparatus is on, but is also used to generate the current used to charge the one or more or series of batteries 50 used in the apparatus 100.

As can easily be appreciated, the automatic nature of the switching of the magnetic fields inside the coils 40 means that no additional energy or power is needed to operate the device other than the maintenance of the magnets 10 moving inside the coils 40. This feature greatly reduces any drain on battery power, as such the only power required to initiate the action of the apparatus 100 is the ability to start the magnets 10 in motion; once started they will reach a faster velocity due to the constant pushing and repulsion of the like poles as the magnets 10 are leaving the coils 40. At some point, this reaches a stabilizing effect wherein the magnets 10 reach a constant or relatively constant speed. This feature enables the device to operate smoothly and consistently as a charging device, very little energy is consumed as the power generated is from the magnetic fields produced by the permanent magnets moving in the coils 40.

It is understood that certain energy losses do occur during the passing of electric current through the coils 40. To minimize that effect, the coils 40 can use wires made of superconductive materials as opposed to copper wire. These losses can be expected to be minimized if the coils 40 can use superconductive wires (when they become available) as opposed to copper wires. These superconductive coils and other loss-reducing concepts can be adapted to further maximize the performance of the basic concepts which are defined in the claims.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A geomagnetic power generating apparatus comprises:
a guide means, the guide means forming a closed loop defining a guide path;
one or more moving permanent magnets, each permanent magnet having a north polarity at a first end and a south polarity at the opposite second end, the one or more magnets being located and guided along the guide path by the guide means;
a plurality of coils, each coil being positioned around the guide means, encircling both the guide means and the guide path along which one or more permanent magnets move, each coil having a cross section having an increasing number of windings extending from a minimal winding first end to a maximum winding second end;
a battery or a series of batteries connected to the plurality of coils, and wherein the one or more permanent magnets are moved, with one magnet approaching toward each coil and as the N or S end of the magnet approaches inside the coil an electric current is created having an opposite polarity at the narrow end of the coil relative to the entering end of the magnet, as the movement of the one or more permanent magnets generates an electric current in the coils to charge the battery and as the magnet leaves the thick end of the coil a similar or like pole S to S or N to N polarity exists relative to the second end of the magnet causing the magnetic field of each of the coils to push the similar polarity second end of the magnet out of the coil, propelling the magnet to the next coil wherein the moving magnets generate electric currents within the coils causing a major propulsive magnetic field to act on the magnet thus augmenting its momentum along the guide path.

2. The geomagnetic power generation apparatus of claim 1 wherein the guide means forms a circular guide path.

3. The geomagnetic power generation apparatus of claim 1 wherein the one or more permanent magnets is a plurality of permanent magnets fixed equidistantly from each adjacent magnet.

4. The geomagnetic power generation apparatus of claim 3 wherein the plurality of coils are equidistantly spaced relative to an adjacent coil around the guide means at a distance equal to the fixed distance of the adjacent magnets.

5. The geomagnetic power generation apparatus of claim 1 further comprises a power on switch.

6. The geomagnetic power generation apparatus of claim 5 wherein the power on switch initiates movement of the one or more permanent magnets.

7. The geomagnetic power generation apparatus of claim 1 further comprises a power off switch which stops the movement of the one or more permanent magnets.

8. The geomagnetic power generation apparatus of claim 1 further comprises:
a power conversion means for converting DC power to AC power; and
a plurality of electric plugs or outlets for connecting and powering electric devices.

9. The geomagnetic power generation apparatus of claim 1 wherein the guide means has a single opening with a pair of ends which allows the coils to pass upon assembly and the ends are connected to form a circular guide path.

10. The geomagnetic power generation apparatus of claim 9 wherein the guide means has a circular guide path groove for holding non-magnetic bearings.

11. The geomagnetic power generation apparatus of claim 10 wherein the guide means has a skeletal frame having a plurality of curved ribs into which a ring of equidistantly spaced permanent magnets can be snapped into upon assembly or alternatively fed into an end of the guide means.

12. The geomagnetic power generation apparatus of claim 11 wherein the plurality of magnets rest onto the bearings creating a low friction surface.

13. The power generation apparatus of claim 1 wherein the first end of each of the one or more permanent magnets is aerodynamically rounded.

14. The power generating apparatus of claim 1 wherein the closed loop is oval or circular.

15. The power generating apparatus of claim 1 wherein each permanent magnet is fixed relative to other permanent magnets by a connecting structure.

16. The power generating apparatus of claim 15 wherein the number of permanent magnets is equal to the number of coils.

17. The power generating apparatus of claim 15 wherein each permanent magnet is spaced equidistantly on the connecting structure.
